(19) United States
(12) Patent Application Publication
(10) Pub. No.: US 2010/0128368 A1
(43) Pub. Date: May 27, 2010

(54) Z-Translation Mechanics; the Z-translating optical electro-mechanical allignment system

(76) Inventor: Jeffrey Max Belicofski, Sydney (AU)

Correspondence Address: Helen Gardner, 4 Style Drive, Aliso Viejo, CA, 92656, US

(21) Appl. No.: 12/313,882

(22) Filed: Nov. 26, 2008

(51) Int. Cl. G02B 7/02; G02B 7/18

(52) U.S. Cl. 359/823; 359/871

(57) ABSTRACT

A Method of assembling optical mounts for the formation of an optical-electronic circuit is disclosed herein. This Z-Translating Optical-Mechanical alignment system had been devised to solve the problem of building a transportable, shoulder mountable, holographic camera. This system allows for easy adjustment in the Z-direction (in Cartesian co-ordinates) with adjustment in the X & Y directions built into the discrete optical mounts forming the circuit and which are now standard components in the opto-electronics industry. This system allows for components such as Laser Mirrors, Laser crystals, Lenses, Beam-splitting cubes, Waveplates, Diffraction Gratings, Spatial Filters, to be assembled in a compact and flexible manner with near perfect alignment and with Electronically controlled fine adjustment in the Z-direction.

### BACKGROUND TO THE INVENTION

Since the time that the first laser was constructed and demonstrated in 1960 by Dr Theodore Maiman at the Hughes Aircraft laboratories, Scientists and Engineers have developed various types of optical mounts to securely and finely position optics such as lenses, front surface mirrors, collimating optics, waveplates and other optical components; these kinematic mounts designed to combine micrometer adjustment to position the optic.

The method so far used in the Electro-Optics industry to secure a mount in place, is for the optical mount to be joined by Grub Screw to a post and for the post to fit into a post holder which is secured to an optical bench. Configurations for external cavity laser resonators and the optical electronic circuits built around these resonators are becoming more complex and with all these optical mounts secured individually to the optical bench, or screwed onto an elongated rail which is fastened down to the optical bench, these complex geometries are requiring large areas of optical bench space.

A problem of crucial significance in the design of optical mounting systems had been incorporating fine positioning in both the X and Y directions about the optic axis. One of the first designs for an optical mount which provided fine adjustment was disclosed by Kaspareck in U.S. Pat. No. 3,596,863.

A design for a lens mount achieving fine micrometer adjustment in the X and Y directions was disclosed by Melmoth in U.S. Pat. No. 3,989,358 and a design for an optical positioning stage which provides for precision movement in the X and Y directions about the optic axis and also in the Z-direction along the optic axis was disclosed by Mauro in U.S. Pat. 4,652,095. A lens mount for positioning of a cylindrical lens that incorporates an elongated rail providing for movement of the mount in the Z-direction was disclosed by Bedzyk in U.S. Pat. No. 5,194,993. This lens mount has the advantage of being a rigid fixture but is however, a bulky component. A mirror mount which provides flexibility in it's use when secured to an optical test bench was disclosed by Luecke in U.S. Pat. No. 5,737,132

### SUMMARY OF THE INVENTION

This “Z-translating Optical Electro-Mechanical Alignment system” was developed to solve part of the problem of building a Transportable holographic Camera ; A necessity in assembling such a camera is that there needs to be ultra-fine adjustment along the optic-axis; the “Z” direction; especially for the adjustment of a microscope objective in the spatial filter. Ultra-fine adjustment can also be used with a diffraction grating pair to separate the modes in a laser Beam.

Holographic Video Systems that are currently being developed also require positioning by ultra-fine adjustment along the optic axis; the Z-direction.

In Using the “Z-translation Mechanics” : adjustment along the Z-direction is Electronically controlled. Methods of Adjustment of the optic mount in the X and Y directions is achieved manually and can be built into the mounts but will not be described here in this disclosure. Methods for designing optical mounts incorporating fine positioning in the X and Y directions and rotational and pivotal movements are described by Jue in U.S. Pat. No. 4,655,548 and Sechist and Nunnally in U.S. Pat. Nos. 5,757,561 and 6,016,230 and Dallakian describes a Pivoting Gimballed mount in U.S. Pat. No. 6,198,580

Screws already used in Optical Mounts and translation stages having ultra-fine threads of 80 pitches per inch are now an Electro-optics industry standard. Motorized Actuators are now standard components in the Electro-Optics industry; Z-translation Mechanics provides a flexible and compact method of assembling and positioning optical mounts in near perfect alignment to form an optical-electronic circuit with ultra-fine electronically controlled adjustment in the Z-Direction.

As laser Resonators become more and more complex, it will be seen that Z-translation mechanics provides for the simple assembly of a large number optical mounts in a minimum space. These complex arrangements that are currently built onto optical bench plates can be built into transportable shoulder carrying equipment using Z-translation Mechanics

### BRIEF DESCRIPTION OF THE DRAWINGS FIG. 1; Optical mount showing distances #(X-X) and #(Y-Y) which can hold a 1 inch optic

FIG. 2 Motorized Actuator holding mount

FIG. 3 ⅔ “D” ROD

FIG. 4 Post to mount holding block

FIG. 5 Mount to hold 1 inch optic

FIG. 6 Motorized actuator holding mount

FIG. 7 Parts to form adjustable 1 inch mirror mount

FIG. 8 Optical mount to hold 2 inch optic

FIG. 9 Mirror holding mount with swivel about the horizontal

FIG. 10 Mount to hold end of fiber-optical cable; and two compression springs and two fine adjustment screws

FIG. 11 Mount for fine adjustment of a Pinhole

FIG. 12 Mount to hold Lens array of FIG. 15

FIG. 13 Termination frame

FIG. 14 Mount to hold laser rod and circular circuit board for end pumping of laser rod

FIG. 15 Diode lens array; Jacketed fiber-optic cable terminate at the base

FIG. 16 Mount to hold 1 inch square diffraction gratings. Holding frame needs to swivel around the horizontal

FIG. 17 Miniature Z-translating system built around 1 inch optics

FIG. 18 Motorized Actuator with cable and connector

FIG. 19 Post to mount block connected to a mount

FIG. 20 Mount positioned between termination frames (only one frame shown)

FIG. 21 beam deflection around a circuit

### DETAILED DESCRIPTION OF THE PREFERRED EMBODIMENTS

OPTICAL MOUNTS AND COMPONENT HOLDERS

⅔ “D” ROD

MOTORIZED ACTUATORS

POST TO MOUNT BLOCK AND TERMINATION FRAME

### Optical Mounts and Component Holders

This Z-translating Optical Mechanical alignment system requires that the optical mounts be designed such that the mounts slide along a semi-circular Rod. This rod is shown in FIG. 3.

It is recommended that this Rod be of stainless steel and that the diameter of the rod be ¾″ (9.53 mm) for a Z-translating system built around 1 inch optics. It is recommended that ⅓ of the Diameter of this steel Rod be shaved off which can easily be achieved using milling machinery.

Shown in FIG. 1 is an optical mount designed to hold a 1 inch circular optic. It is necessary to mention that these optical mounts shown in FIG. 1 through to FIG. 16 are built around 1 inch optics; these mounts can be designed to hold components up to 2 inches in diameter.

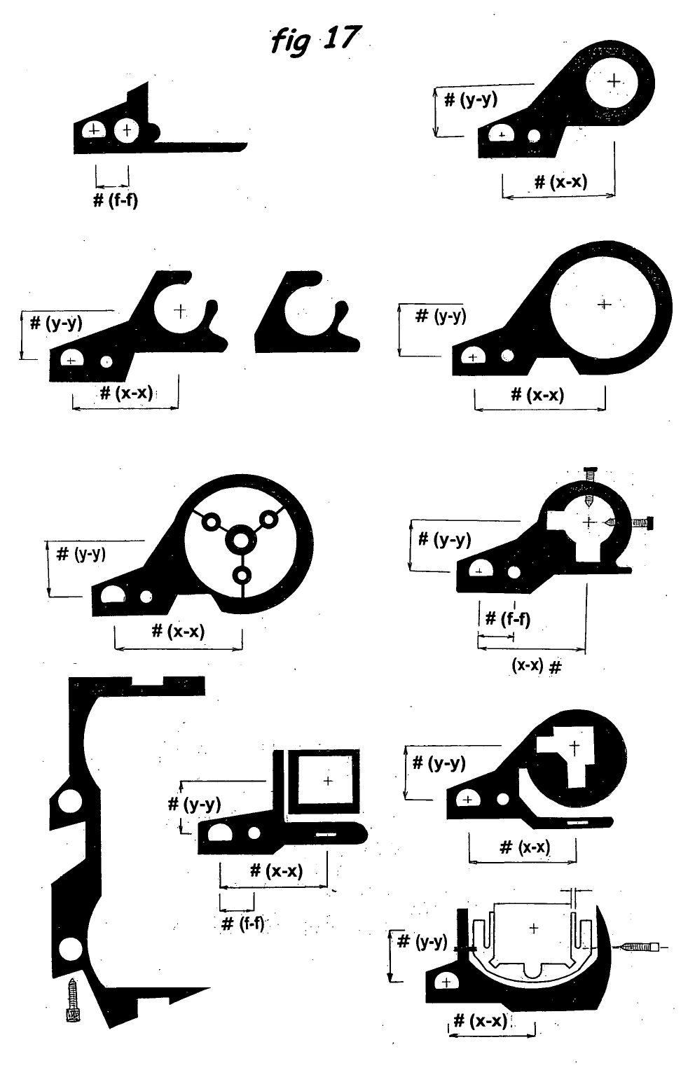

Shown in FIG. 17 is a miniature version of the same mounts built around ½inch optical components; these mounts can hold components up to 1 inch in circular diameter and for the purpose of building a transportable shoulder mountable holographic camera this system is most adequate.

The design of these optical mounts is such that the distances #(X-X) and #(Y-Y) which are to be measured from the centre of the sliding Rod to the optic axis is precisely identical for each optical mount in the series. These distances #(X-X) and #(Y-Y) as measured from the centre of the sliding Rod to the optic axis are distances that need to be agreed upon by manufacturers of optical mounts within the Electro-Optics industry. But for a Z-Translating system built around 1 inch optics it is suggested that #(X-X) be 1 inch (25.4 mm) and #(Y-Y) be 2 inches (50.8 mm)

It is suggested that for a Z-translating system built around ½ inch optics it is suggested that #(X-X) be 1 inch (25.4 mm) and that #(Y-Y) be ½ inch (12.7 mm) but as stated, the dimensions #(X-X) and #(Y-Y) are dimensions that the Electro-Optics industry need to agree on for the system to become a viable building block throughout industry.

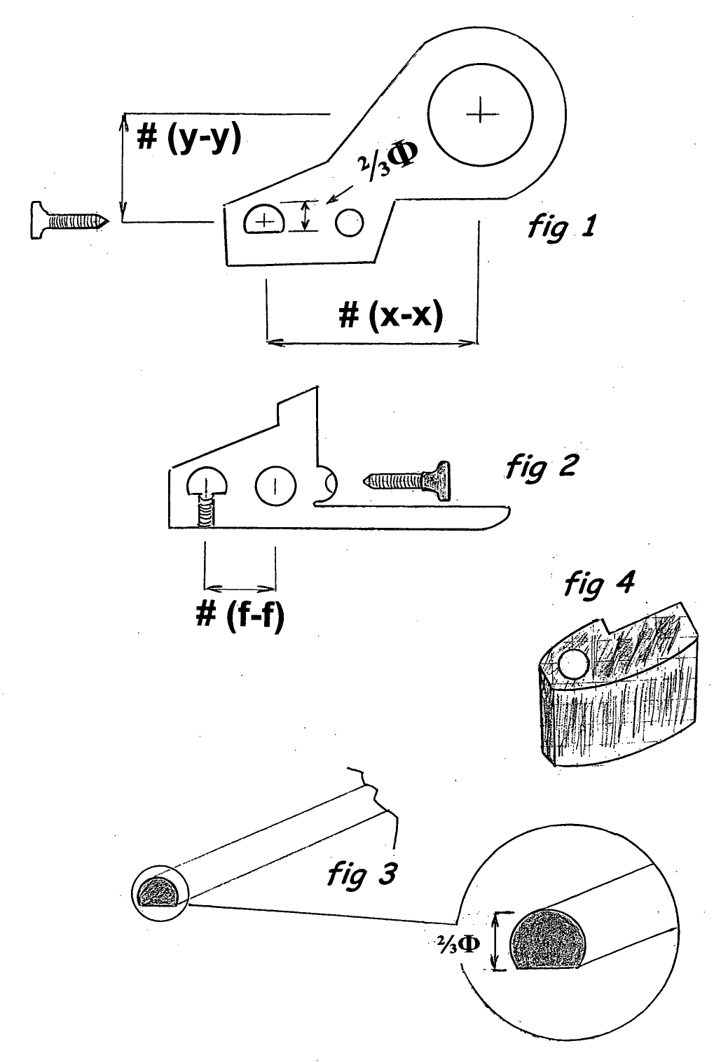

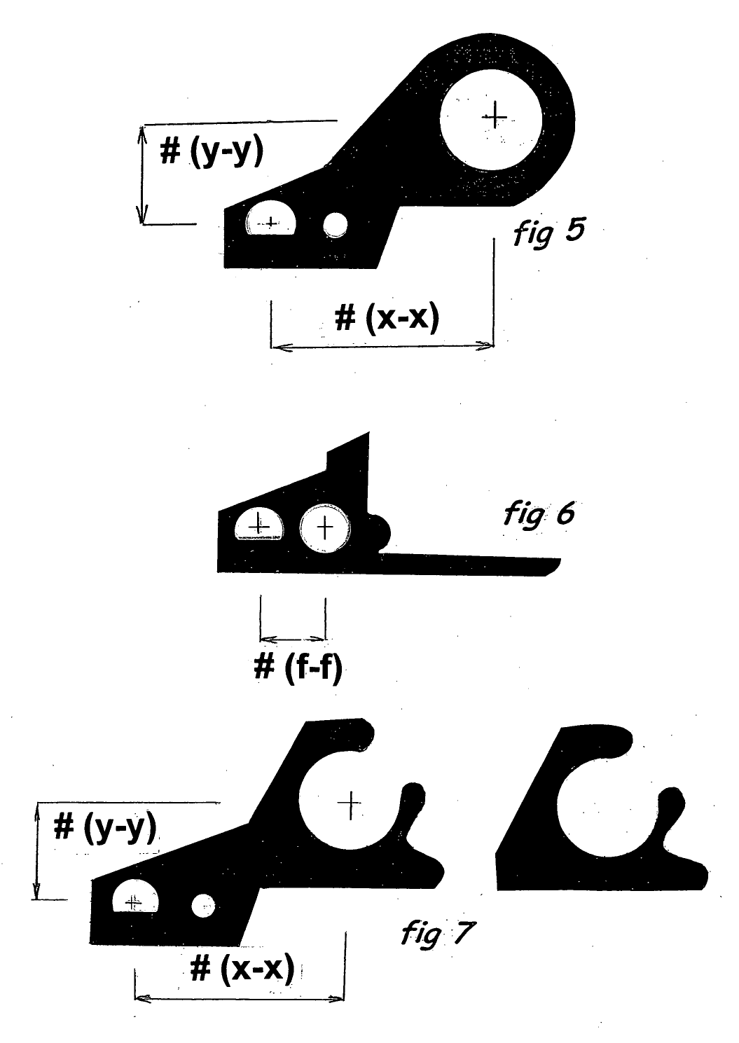

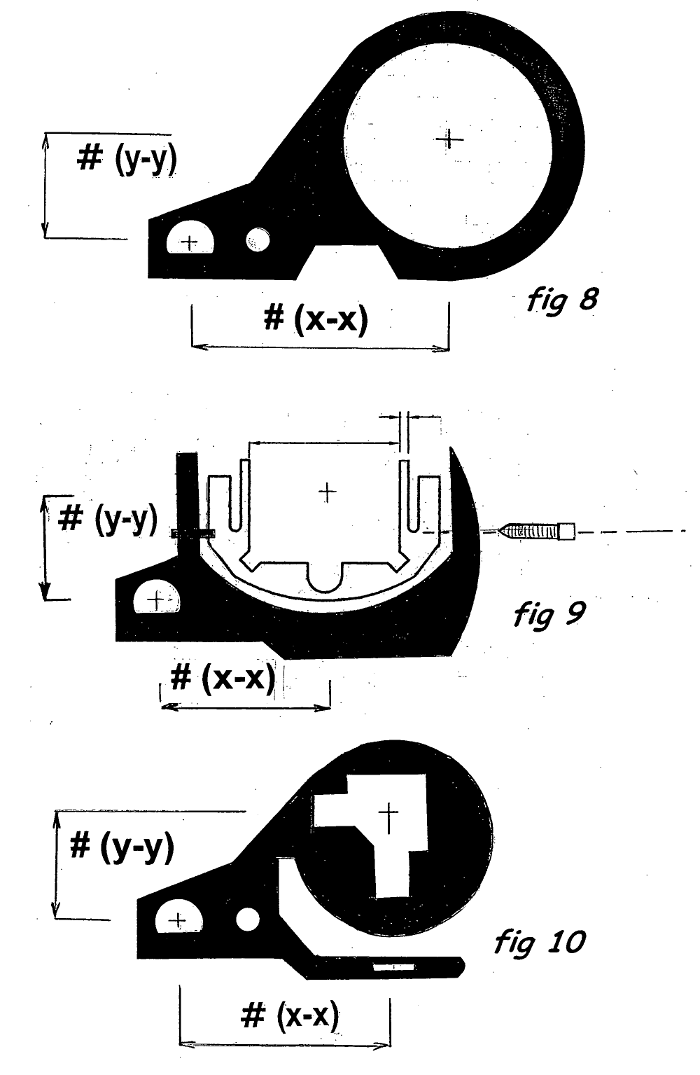

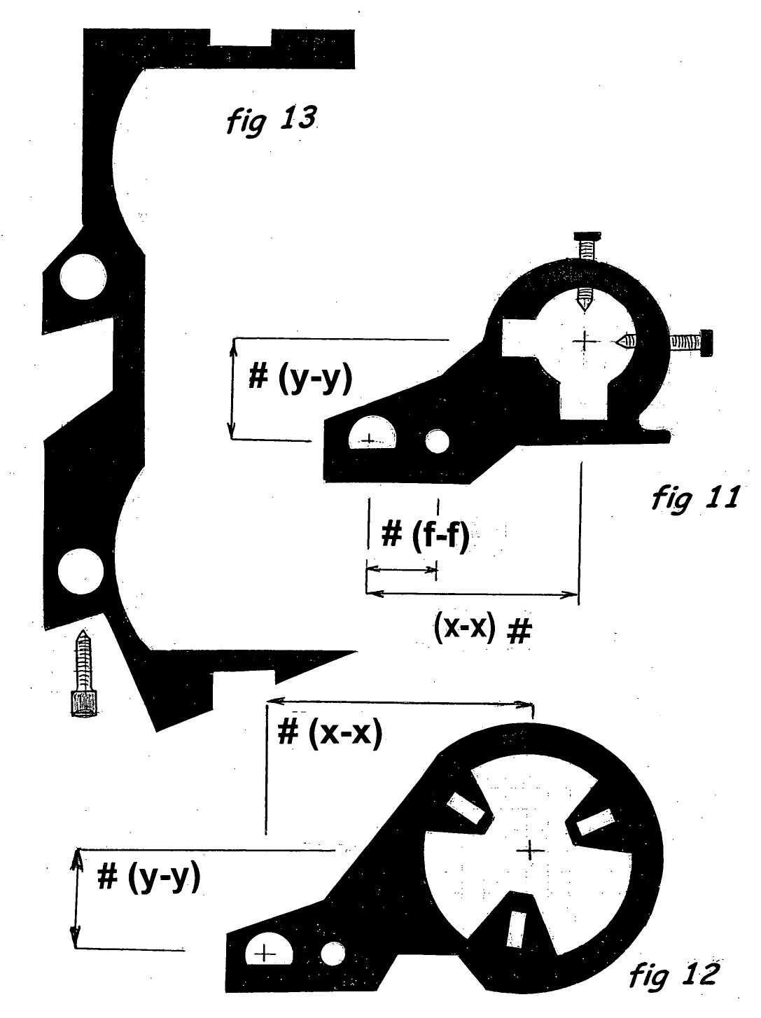

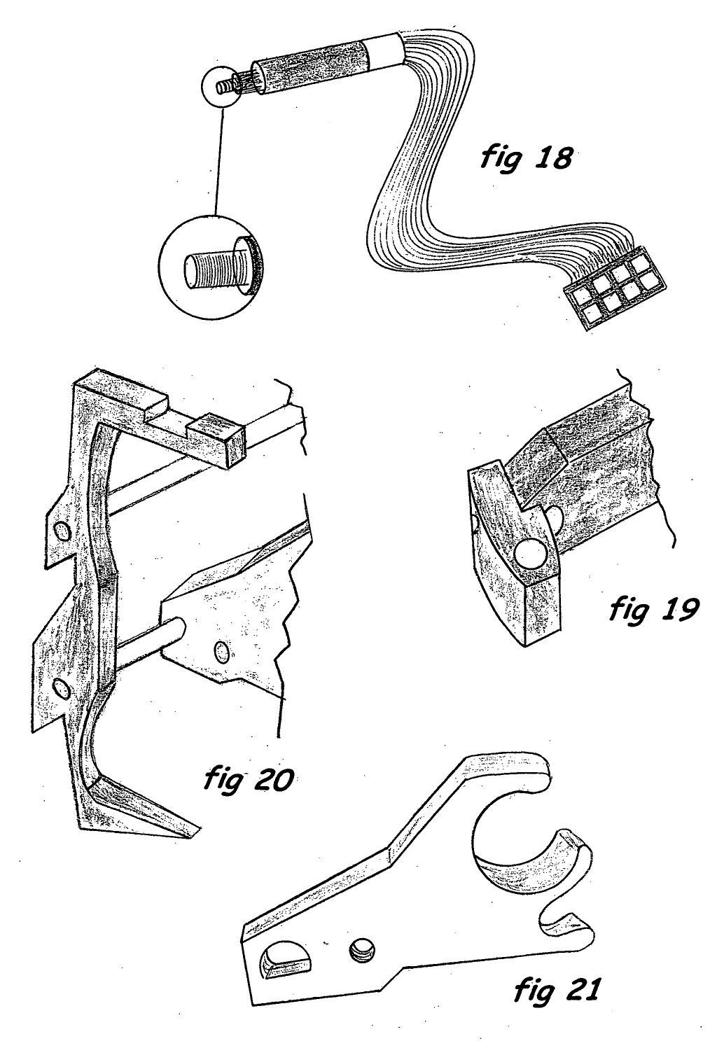

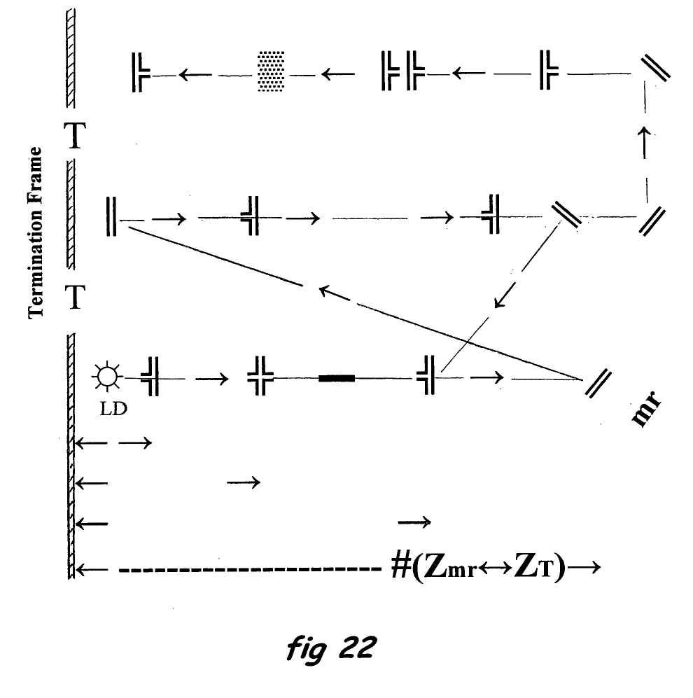

Ultra-fine adjustment of the optical mounts along the optic axis is easily achieved. The mount required is shown in FIG. 2 and referred to herein as the “Motorized Actuator Holding mount”. This component will hold a motorized actuator and will be fastened stationary to the semi-circular steel ‘D’ Rod by a screw, preferably a grub screw. The motorized actuator (FIG. 18) can be held securely in this mount by a Hex screw as shown in FIG. 2.

The additional hole on this mount is to insert the motorized actuator and the small hole in the optical mounts shown through FIG. 1 through to FIG. 16 requires a fine screw thread of which the fine screw thread of the actuator screws into.

It is necessary to be aware that the Grub screw drawn on the component of FIG. 2 will only be seen if this component is made from clear plastic, otherwise it will not be seen.

This motorized holding mount of FIG. 2 is held stationary on the stainless steel “D” Rod by the Grub screw, but the optical mount which the actuator is attached to is left to slide freely on the stainless steel “D” Rod

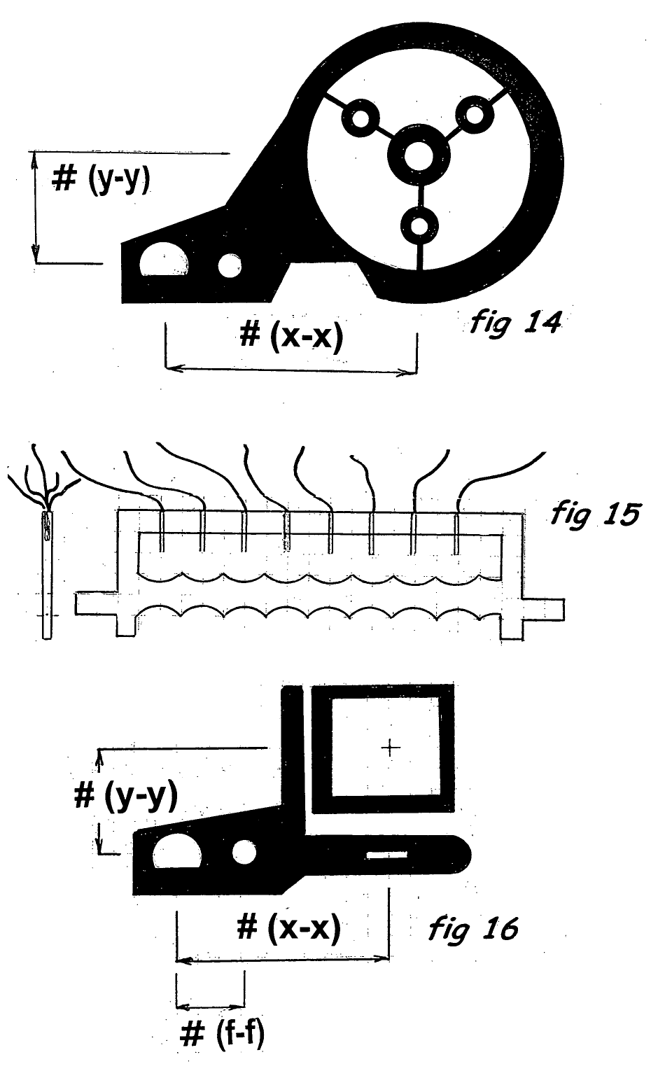

The optical mounts shown in FIGS. 1 through to 16 are generally standard Mounts used in the Electro-Optics industry except for the mounts shown in FIG. 12; FIG. 14; and FIG. 16.

Shown in FIG. 14 is a mount to hold a laser diode for end pumping of a laser rod; Two of these mounts would be needed to form the holding mount for the laser rod and pumping diode; the laser rod is held in each mount in the centre hole and at one end a circuit board in the shape of a disc is attached by bolts to the three outer holes. The circuit board will contain a laser diode for end pumping of the laser rod.

Shown in FIG. 12 is a mount to hold laser Diode Lens Arrays for side pumping of a laser rod using these diode lens arrays. The pump radiation is fed into the diode lens array through fiber-optical cable as shown in FIG. 15; each fiber-optical cable terminates into the Base of the diode lens array the diode lens array shown in FIG. 15 is cut out of 3mm thick clear acrylic sheet. The advantage of using this diode lens array for coupling the pump radiation into the laser rod is that the radiation exits from the array as a thin stream and it is possible to obtain the fundamental mode from the laser which is necessary for holography.

A copper disc can be held within the interior of this mount with the laser Rod being held in place, at each end of the mount, within the centre of the copper disc.

Shown in FIG. 16 is a mount to hold diffraction grating which should swivel about the horizontal axis.

The industry standard is for the optical mounts to be made from Aluminum and the finish on the mount is made by “Anodizing”; the electrochemical conversion of the Aluminum surface to an Aluminum oxide. The Anodized coating is extremely hard and can be colored by either organic dyes or inorganic metal compounds.

### ⅔ “D” Rod

As stated in 0040) this ⅔ “D” Rod should be of stainless steel with a diameter of ¾ inch (9.53 mm), and it is suggested that ⅓ of the rod be shaven off.

A section of this rod should not be longer that 1 meter otherwise it could sag slightly and even the slightest sag of this “D” rod would be enough to impair the circuit. It is possible for this “D” rod to be formed from a strong polymer with a comparable rigidity of that of steel.

### Motorized Actuators

Miniature motorized actuators recently developed in the Electro-optics industry can be incorporated into these Z-translating optical mounts to provide electronically controlled ultra-fine adjustment of an optical mount along the optic axis.

Motorized actuators developed by the industry use ¼-80 ultra-fine screw threads. This is a screw thread with a pitch of approximately 0.3 mm The standard motorized actuator allows for up to 12 mm of actuator travel. The motorized actuator is shown in FIG. 18 with cable and connector.

### Post to Mount Block and Terminating Frame

The “Post to mount block” shown in FIG. 4 can be used to connect an optical mount to a post. The block is screwed onto the mount as shown in FIG. 19.

The termination frame shown in FIG. 13 and again in FIG. 20 is needed where a circuit consisting of two or more “D” rods is required and in this case, the optical mount of FIG. 9 is used as a mirror holder to deflect a light beam in the 2-dimensional plane of the system. The interior part of this optical mount is attached, such that, a mirror can rotate about a horizontal axis. The Termination Frame shown in FIG. 13 and again in FIG. 20 need not be designed to hold only two “D” rods; it could be designed to hold as many “D” rods as needed.

In drawing a Z-translating system that is intended to convey an experimental set-up for which a laser Scientist can reproduce, the schematic example shown in FIG. 22 can be used, however, a format for designating distances of the optical mounts at positions along the optic axis is suggested. This format is to designate the distance of an optical mount to one of the termination frames. The suggested designation is #(Z_{A} [symbol] Z_{T}) where A=1, 2, 3, 4 etc. Shown in FIG. 22 are optical mounts forming a circuit held between two Termination Frames

I claim:

1. An optical electronic Mount assembly comprising of a semi-circular rail which needs to be equal or greater then ⅜ inch (9.53 mm) in diameter and also comprising of specialty designed optical mounts having an extended side frame with a semi-circular shaped hole such that the optical mount can slide along the semi-circular rail, and such that the distance between the optic axis and the centre of the semicircular hole of the extended side frame is no less than 2 inches (50.8 mm)

2. An optical electronic mount assembly of claim 1 which can comprise of a multitude of different optical mounts such as mirror mounts, lens holders, spatial filter mounts, Fiber-optic mounts, plate holding mounts, that provides for perfect alignment of the optical components held in these mounts along the optic axis.

3. Specialty deigned optical mounts of claim 1 which can comprise of the mount and also an accessory part held stationary onto the semicircular rail; this accessory part holding a motorized actuator attached to the optical mount such that electronically controlled fine adjustment of the optical mount along the optic axis can be achieved.

4. An optical electronic mount assembly comprising of a semi-circular rail which needs to be equal or greater than ⅜ inch (9.53 mm) in diameter and a multitude of optical mounts having an extended side frame such that the distance between the optic axis and the centre of the semicircular hole of the extended side frames of these optical mounts is no less than 2 inches (50.8 mm); this mount assembly being able to be suspended in space by attaching each end of the semi-circular rail to a fixture
